(19) United States
(12) Patent Application Publication
(10) Pub. No.: US 2021/0107104 A1
(43) Pub. Date: Apr. 15, 2021

(54) Rivet Pattern Pitch Gauge

(71) Applicants: Matthew Baker, Claremore, OK (US); Daniel Baker, Claremore, OK (US)

(72) Inventors: Matthew Baker, Claremore, OK (US); Daniel Baker, Claremore, OK (US)

(21) Appl. No.: 17/013,752

(22) Filed: Sep. 7, 2020

Related U.S. Application Data
(60) Provisional application No. 62/897,485, filed on Sep. 9, 2019.

(51) Int. Cl. B23Q 3/00; G01B 5/14

(52) U.S. Cl. CPC B23Q 3/005; G01B 5/14

(57) ABSTRACT

The Rivet Pattern Pitch Gauge is a tool designed to properly space rivets or other fasteners in an aircraft skin repair. The tool consists of a straight edge with measure markings, a row of teeth set at a forty-five degree angle, and a corner that has a half inch radius gauge built in. The tool uses the teeth, which are six times the diameter of the fastener in height and length, to evenly space the fasteners when laying out the aircraft skin repair. It is this spacing coupled with the forty-five degree angled teeth that allow for accurate and quick repair layouts and that differentiate the Rivet Pattern Pitch Gauge from other fastener spacing tools.

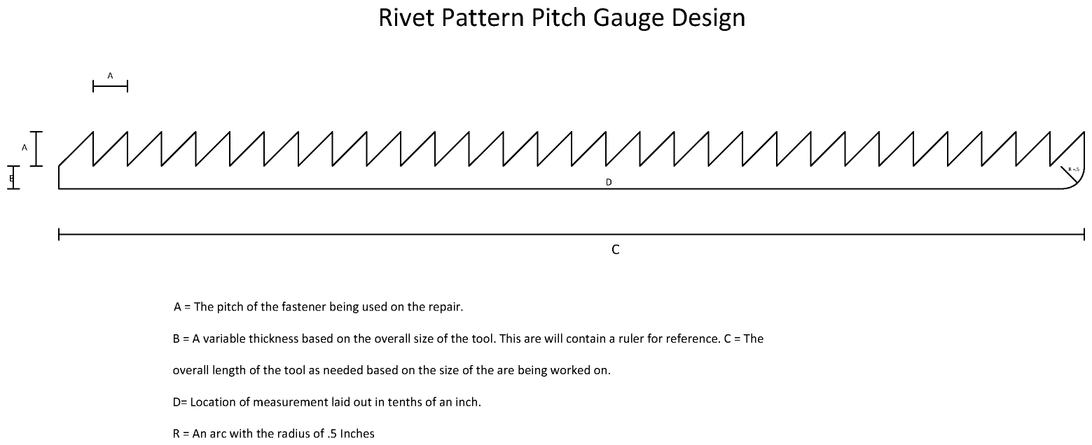

The Rivet Pattern Pitch Gauge is a tool to quickly and efficiently measure out the standardized spacing of fasteners in aircraft repair. It is a flat tool made from plastic, metal, or any other flexible material that can hold its shape but be flexible enough to follow the contours of the aircraft. The shape of the tool is approximately 2 inches wide by 22 inches long, though the size can be increased or decreased based on the repair area size on the aircraft. The tool is a series of 45% slopes with a height equal to the pitch (distance between fasteners) needed on the specified aircraft repair, based on the size of the fastener. The “pitch” is determined by aircraft manufacturer guidelines and is a multiple of the diameter of the fastener, usually between 4 and 6 times the diameter of the fastener. The slopes occur on the tool in the frequency equal to the pitch based on the size of the fastener used. At the bottom, flat, edge of the tool is a ruler with standard measure; usually expressed in, though not limited to, tenths of an inch. On the bottom right edge of the Rivet Pattern Pitch Gauge is a rounded corner with a 90 degree arc. This arc is for measuring the corners of the repair which are required to be rounded.

The gauges sizes are set at the aircraft manufacturer's max pitch allowed for the fastener diameter. When used properly, the repair will stay within guidelines set by the aircraft manufacturer while simultaneously using the minimum amount of fasteners required for the repair. The individual gauges will be labeled with the fastener size as well as the multiple of the diameter that the pitch on the gauge is set at.

Though the tool is conceived for aircraft repair, the sizes and spacing of the tool can be manufactured at any size specifies where a standard repeating layout for any fastener type is needed in any construction or repair application. This can be accomplished by changing the distance of the spacing between teeth as well as the high of the teeth to equal the desired spacing between fasteners.

### DESCRIPTION OF MANUFACTURE

The Rivet Pattern Pitch Gauge is cut out of a sheet of Lexan by a computer controlled router. The blank tool is then screen printed on to add the measurements and identifying markings.

### DESCRIPTION OF USE

In order to use the Rivet Pattern Pitch Gauge one would draw a straight line between where the first and last fasteners, in that row of fasteners, on the repair area will be secured on the body of the aircraft. Then the tip of the first tooth of the pitch gauge will be placed on the location of the first fastener and rotated so that the location of the last fastener intersects with the slope on the appropriate tooth of the pitch gauge. At this point, a line can be drawn on each of the slopes of the pitch gauge, intersecting with the line drawn earlier (between the first and last fasteners). These intersections will accurately mark the desired, equidistant, location of all fasteners in the row of fasteners on this portion of the repair. This process will be repeated until the entire repair has been laid out and is ready to be secured.

The Rivet Pattern Pitch Gauge can be used with any type of fasteners that are required to be laid out at any set interval. In order to do this, the tool will need to be produced with the teeth in intervals equal to the desired interval of the fastener.

1. The Rivet Pattern Pitch Gauge is a tool designed to properly space rivets or other fasteners in an aircraft skin repair. The tool consists of a straight edge with measure markings, a row of teeth set at a forty-five degree angle, and a corner that has a half inch radius gauge built in. The tool uses the teeth, which are six times the diameter of the fastener in height and length, to evenly space the fasteners when laying out the aircraft skin repair. It is this spacing coupled with the forty-five degree angled teeth that allow for accurate and quick repair layouts and that differentiate the Rivet Pattern Pitch Gauge from other fastener spacing tools.
